(19) United States
(12) Patent Application Publication
(10) Pub. No.: US 2021/0098848 A1
(43) Pub. Date: Apr. 1, 2021

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); SUMITOMO ELECTRIC PRINTED CIRCUITS,INC., Shiga (JP)

(72) Inventors: Shinichi TAKASE, Mie (JP); Hideo TAKAHASHI, Mie (JP); Isamu HAMAMOTO, Mie (JP); Yoshifumi UCHITA, Shiga-ken (JP); Takayuki TSUMAGARI, Shiga-ken (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); SUMITOMO ELECTRIC PRINTED CIRCUITS,INC., Shiga (JP)

(21) Appl. No.: 17/044,568

(22) PCT Filed: Apr. 4, 2019
(86) PCT No.: PCT/JP2019/014999

§ 371 Date: Oct. 1, 2020

(30) Foreign Application Priority Data
Apr. 18, 2018 (JP) 2018-079912

(51) Int. Cl. H01M 50/519; H01M 50/505

(52) U.S. Cl. CPC H01M 50/519; H01M 2220/20; H01M 50/505

(57) ABSTRACT

A wiring module includes a flat line that is mounted on a power storage element group including power storage elements and a line-side connector that is to be fitted to a device-side connector included in a control unit of the power storage element group. The flat line includes an extra section extending from the power storage element group and a bending restricting plate is disposed on a portion of the extra section.

### TECHNICAL FIELD

The technology disclosed herein relates to a wiring module.

### BACKGROUND ART

A wiring module to be mounted on power storage elements that is described in Japanese Unexamined Patent Application Publication No. 2015-156329 has been known. The wiring module includes a voltage monitoring line at an electrode post of the power storage element. The voltage monitoring line includes a connection line having flexibility such as a flexible flat cable (FFC) or a flexible printed circuit board (FPC). A connection connector is connected to one end of the voltage monitoring line. The connection connector is connected to a device-side connector included in a voltage monitoring unit.

### RELATED ART DOCUMENT

### Patent Document

[Patent Document 1] Japanese Unexamined Patent Application Publication No. 2015-156329

### SUMMARY OF THE INVENTION

### Problem to be Solved by the Invention

The connection connector is fitted to the device-side connector as follows, for example. The power storage element including the wiring module is fixed in a predefined position and the device-side connector is fixed in a predefined position. The connection connector is moved closer to and opposite the device-side connector and pushed into the device-side connector. Thus, the connection connector and the device-side connector are fitted to each other.

In performing the above fitting operation, the voltage monitoring line necessarily includes an extra section having a length required for the connection connector to be moved closer to and opposite the device-side connector and a length required for the connection connector to be pushed into the device-side connector. The extra section is necessarily moved to follow the connection connector during the fitting operation of the connection connector and the device-side connector.

However, if the voltage monitoring line is configured such that the extra section can be always moved freely, the extra section and the connection connector may be moved and come into contact with a foreign obstacle. For example, any problems may be caused in the extra section or the connection connector due to vibrations caused in transportation of the wiring module before the fitting operation of the connection connector and the device-side connector. Furthermore, for example, any problems may be caused in the extra section or the connection connector due to vibrations caused in transportation of the wiring module after the connection connector and the device-side connector are fitted to each other and mounted on a vehicle.

The technology described herein was made in view of the above circumstances. An object is to provide a wiring module that suppresses an extra section from moving freely as necessary.

### Means for Solving the Problem

The technology described herein is related to a wiring module including a flat line that is mounted on a power storage element group including power storage elements and is one of a flexible printed circuit board and a flexible flat cable, and a line-side connector that is connected to an end portion of the flat line and to be fitted to a device-side connector included in a control unit of the power storage element group. The flat line includes an extra section extending from the power storage element group and a bending restricting plate is disposed on a portion of the extra section.

According to the above configuration, the portion of the extra section where the bending restricting plate is disposed is less likely to be bent. This suppresses the extra section from moving freely due to vibrations. Therefore, the extra section is less likely to be deformed or come in contact with any obstacles. On the other hand, the portion of the extra section where the bending restricting plate is not disposed is allowed to move to follow the movement of the line-side connector.

Embodiments of the technology described herein may preferably include configurations as follows.

The extra section may include a first bending portion and a second bending portion and the first bending portion may be closer to the device-side connector with respect to the bending restricting plate and the second bending portion may be closer to the power storage element group with respect to the bending restricting plate. At least one of the first bending portion and the second bending portion may have a curved surface.

According to the above configuration, even if the positions of the power storage element group and the device-side connector do not correspond to each other, one of the first bending portion and the second bending portion having a curved surface is deformed and warped to absorb such a position displacement.

The extra section may be folded at the first bending portion and have a curved surface at the second bending portion.

According to the above configuration, it is clear that the portion extending from the first bending portion to the device-side connector corresponds to a stroke length necessary for the fitting to the device-side connector. This improves operation efficiency for fitting the line-side connector to the device-side connector.

The flat line may include an extended section that extends outwardly from a side edge thereof and the extended section may be connected to a bus bar at an end thereof and the bus bar may be connected to at least one of electrode terminals included in the power storage elements.

According to the above configuration, the extended section of the flat line is connected to the bus bar that is connected to the electrode terminal of the power storage element. Therefore, compared to the configuration including multiple lines for detecting voltages of the power storage elements, the space can be saved.

### Advantageous Effects of Invention

According to the technology disclosed herein, an extra section of a flat line is suppressed from moving freely as necessary.

### BRIEF DESCRIPTION OF THE DRAWINGS

FIG. 1 is a perspective view illustrating a power storage module according to a first embodiment.

FIG. 2 is a partial enlarged side view illustrating a line-side connector and a device-side connector that are fitted to each other.

FIG. 3 is a perspective view illustrating a separator.

FIG. 4 is a perspective view illustrating a power storage element group including power storage elements that are arranged in the separator.

FIG. 5 is a perspective view illustrating the power storage element group where a wiring module is mounted and the wiring module including an extra section of a flat line.

FIG. 6 is a partial enlarged view illustrating the extra section of the flat line.

FIG. 7 is a perspective view illustrating a holding member.

FIG. 8 is a partial enlarged side view illustrating the power storage module including the extra section that is bent at a first bending portion and a second bending portion.

FIG. 9 is a plan view illustrating the power storage module before the line-side connector and the device-side connector are fitted to each other.

### MODES FOR CARRYING OUT THE INVENTION

### First Embodiment

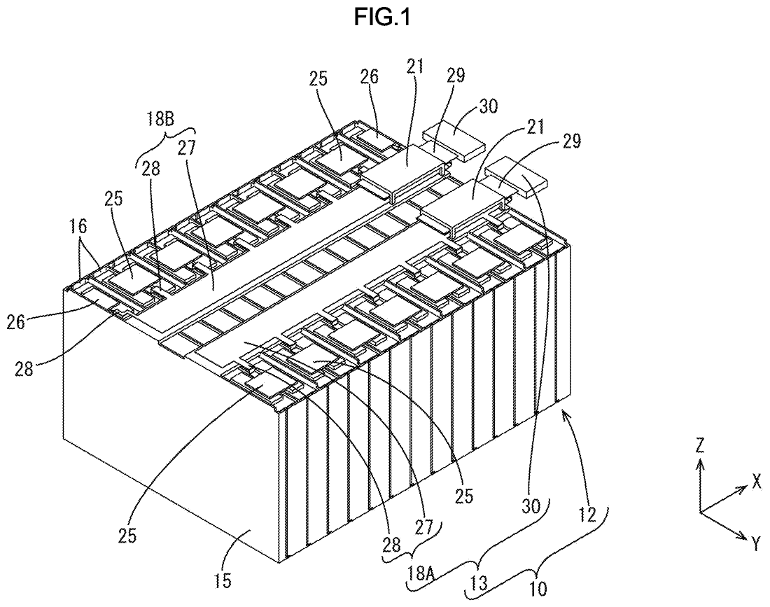

A first embodiment of the technology disclosed herein will be described with reference to FIGS. 1 to 9. A power storage module 10 according to this embodiment includes a power storage element group 12 including power storage elements 11 and a wiring module 13 that is mounted on the power storage element group 12. The power storage module 10 is used as a driving power of a vehicle such as an electric vehicle, a hybrid vehicle, and a plug-in hybrid vehicle or a power for built-in electric components. In the following description, a Z-direction corresponds to an upper side, a Y-direction corresponds to a front side, and an X-direction corresponds to a left side. A symbol is put on only one of the same components and the symbol may not be put on other ones.

### Power Storage Module 10

The power storage module 10 includes the power storage element group 12 including the power storage elements 11 and the wiring module 13 that is mounted on the power storage element group 12. The power storage element 11 has a parallelepiped shape that is flat in a left-right direction. The power storage element 11 includes electrode terminals 14 on front and rear end portions of an upper surface, respectively. The electrode terminal 14 has a rectangular shape seen from the above. Out of the two electrode terminals 14 included in one power storage element 11, one is an anode terminal and another one is a cathode terminal. The power storage elements 11 are arranged in the left-right direction such that the adjacent electrode terminals 14 have different polarities.

### Separator 15

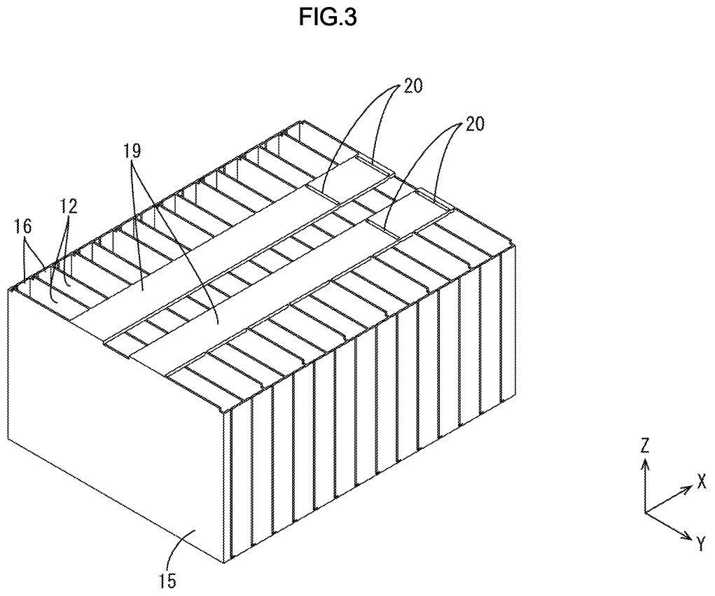

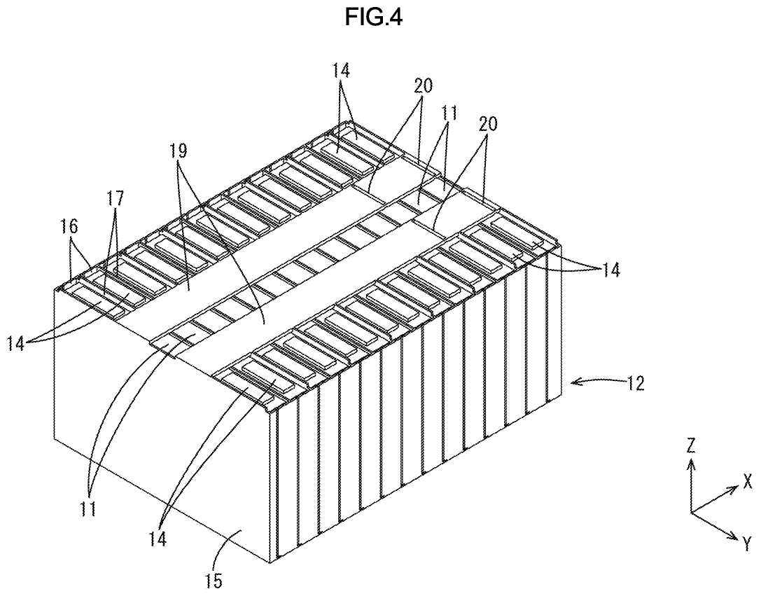

As illustrated in FIG. 4, the power storage elements 11 are arranged in a separator 15 that is made of insulating synthetic resin. As illustrated in FIG. 3, the separator 15 has a rectangular shape seen from the above. The separator 15 includes arrangement sections 16. Each of the arrangement sections 16 has a shape that is same as or slightly greater than an outer shape of each power storage element 11 such that each power storage element 11 can be arranged in each arrangement section 16. The arrangement sections 16 are arranged in the left-right direction. The adjacent arrangement sections 16 are defined by separation walls 17. The separation walls 17 electrically insulate the power storage elements 11 arranged in the respective arrangement sections 16.

The separator 15 includes disposing sections 19 (two disposing sections in this embodiment) where flat lines 18 (described later) are arranged. The disposing sections 19 are spaced from each other. The disposing sections 19 extend from a left edge to a right edge of the separator 15. Each disposing section 19 includes two slits 20 in the left-edge portion. The two slits 20 extend in a front-rear direction and are arranged at an interval in the left-right direction. A holding member 21, which will be described later, is fit to hole edges of the slits 20 and attached to the separator 15.

### Holding Member 21

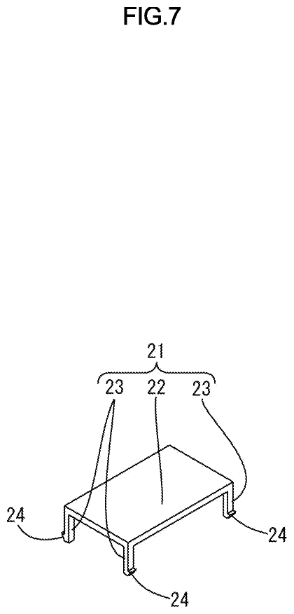

As illustrated in FIG. 7, the holding member 21 is made of insulating synthetic resin. The holding member 21 includes a top plate portion 22 having a rectangular shape seen from the above and leg portions 23 extending downwardly from four corners of the top plate portion 22, respectively. Each of the leg portions 23 has a stopper protrusion 24 that protrudes from a lower end of the leg portion 23 outwardly with respect to the front-rear direction. The stopper protrusions 24 come in contact with the hole edges of the slits 20 of the disposing section 19 from a lower side and the holding member 21 can be attached to the separator 15 so as not to be released from the slits 20 upwardly.

### Bus Bar 25

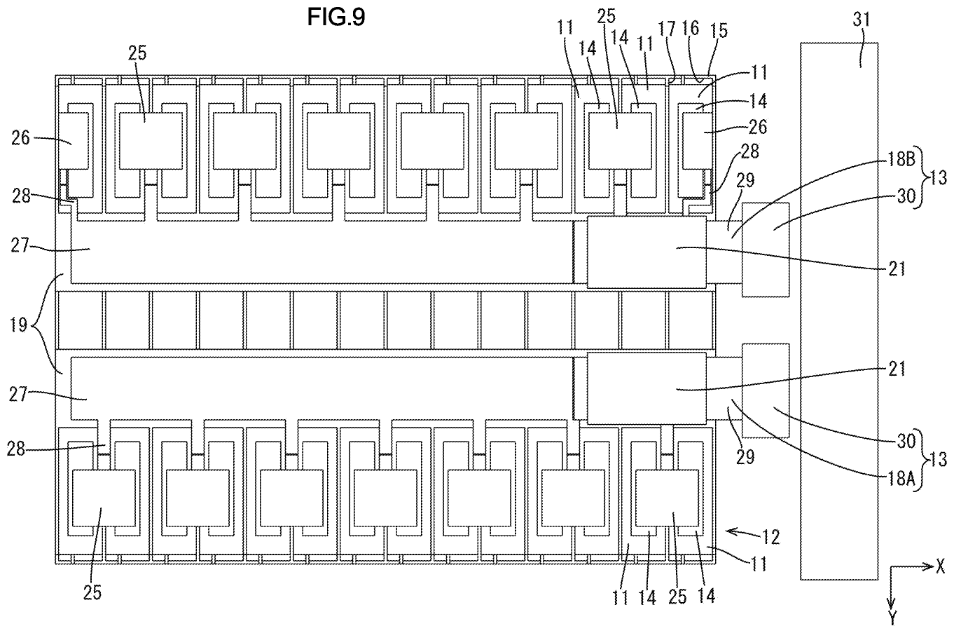

As illustrated in FIG. 9, the adjacent electrode terminals 14 of the power storage elements 11 that are arranged in the left-right direction are electrically connected to each other via a bus bar 25 made of conductive metal. The bus bar 25 is electrically connected to the electrode terminals 14 with a known method such as laser welding, soldering, and brazing. The bus bar 25 has a rectangular shape seen from the above. Metal for the bus bar may be selected as needed from copper, copper alloy, aluminum, and aluminum alloy, for example. A plated layer may be disposed on a surface of the bus bar 25. Metal for the plated layer may be selected as needed from tin and nickel, for example.

### Edge-Side Bus Bar 26

As illustrated in FIG. 9, out of the two electrode terminals 14 arranged on the power storage element 11 that is disposed at a left end, the electrode terminal 14 on the rear end is connected to an edge-side bus bar 26. Out of the two electrode terminals 14 arranged on the power storage element 11 that is disposed at a right end, the electrode terminal 14 on the rear end is connected to the edge-side bus bar 26. The edge-side bus bar 26 is connected to only one electrode terminal 14. The edge-side bus bar 26 is electrically connected to the electrode terminal 14 with a known method such as laser welding, soldering, and brazing. An external terminal, which is not illustrated, is electrically connected to the edge-side bus bar 26 such that power can be supplied from the power storage module 10 to external circuits. Other than the configuration described above, the edge-side bus bar 26 includes the same configuration as that of the bus bar 25 and will not be explained.

### Flat Line 18

The wiring module 13 includes a front-side flat line 18A arranged on a front side and a rear-side flat line 18B arranged on a rear side. The front-side flat line 18A and the rear-side flat line 18B are spaced from each other with respect to the front-rear direction. In the following description, the flat line 18 is generally referred without specifying the front-side flat line 18A or the rear-side flat line 18B. The front-side flat line 18A and the rear-side flat line 18B are flexible printed circuit boards or flexible flat cables. The front-side flat line 18A and the rear-side flat line 18B in this embodiment are flexible printed circuit boards each of which includes an insulating film and conductive lines formed on the insulating film with a print wiring technology.

The front-side flat line 18A includes a body section 27 extending in the left-right direction and extended sections 28 (seven extended sections 28 in this embodiment) extending frontward from the body section 27. The extended section 28 extends downwardly from the body section 27 at a right angle and is bent at right angle toward the front side. Thus, the extended section 28 has a shape of a crank. The front end portion of the extended section 28 is below the bus bar 25. The insulating film is removed from a portion of the front end portion of the extended section 28 corresponding to the bus bar 25 and the conductive line is exposed outside. The exposed conductive line and the bus bar 25 are electrically connected to each other with a known method such as welding, soldering, and brazing.

The rear-side flat line 18B includes the body section 27 extending in the left-right direction and extended sections 28 (eight extended sections 28 in this embodiment) extending frontward from the body section 27. The extended section 28 extends downwardly from the body section 27 at a right angle and is bent at right angle toward the front side. Thus, the extended section 28 has a shape of a crank. The rear end portions of the extended sections 28 on the right end and the left end are below the edge-side bus bars 26, respectively. Among the extended sections 28, the rear end portions of the extended sections 28 other than the ones on the right end and the left end are below the bus bars 25, respectively. The insulating film is removed from a portion of the rear end portion of the extended section 28 corresponding to the bus bar 25 or the edge-side bus bar 26 and the conductive line is exposed outside. The exposed conductive line and the bus bar 25 or the edge-side bus bar are electrically connected to each other with a known method such as welding, soldering, and brazing.

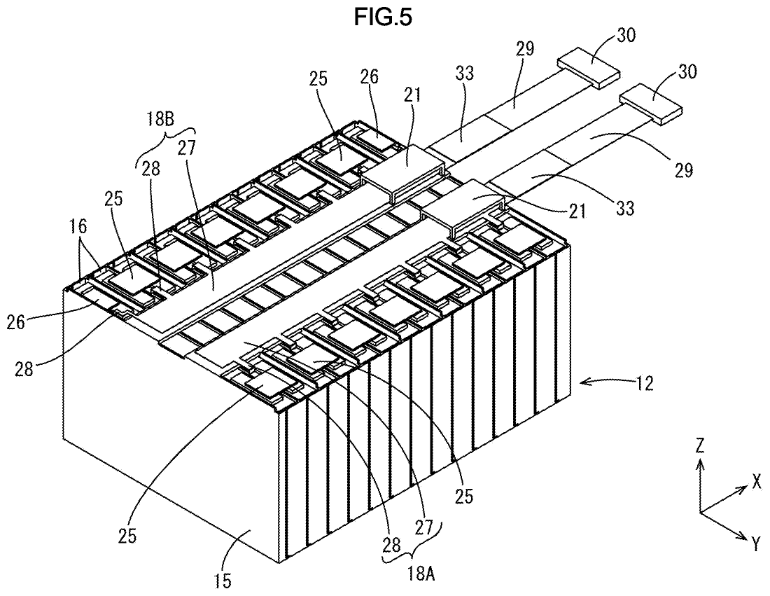

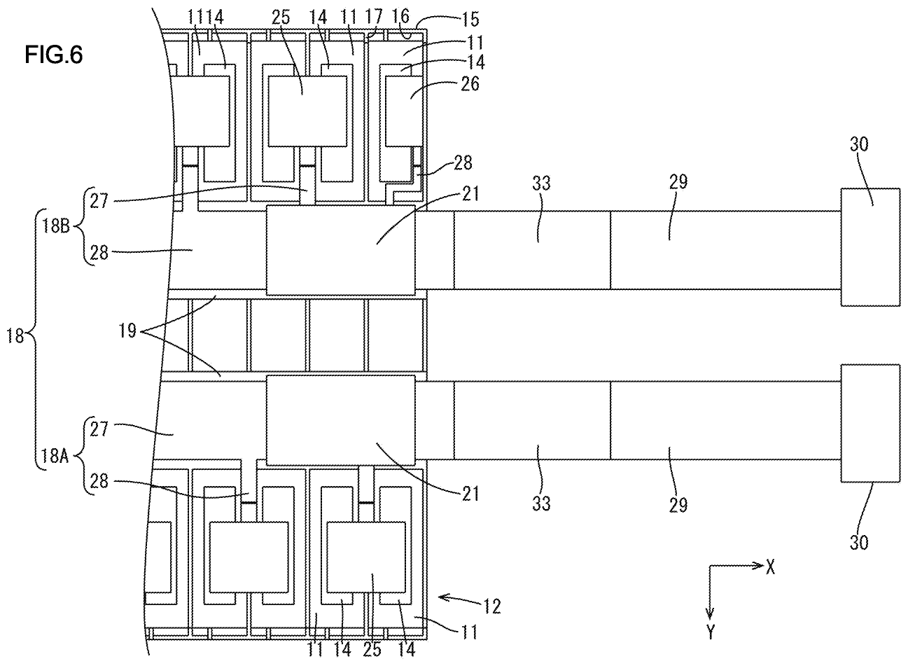

As illustrated in FIGS. 5 and 6, the flat line 18 includes an extra section 29 that extends leftward from a left edge portion of the power storage element group 12. A line-side connector 30 is connected to a left end portion of the extra section 29. The line-side connector 30 includes a terminal, which is not illustrated, therein. The terminal is electrically connected to each conductive line of the flat line 18.

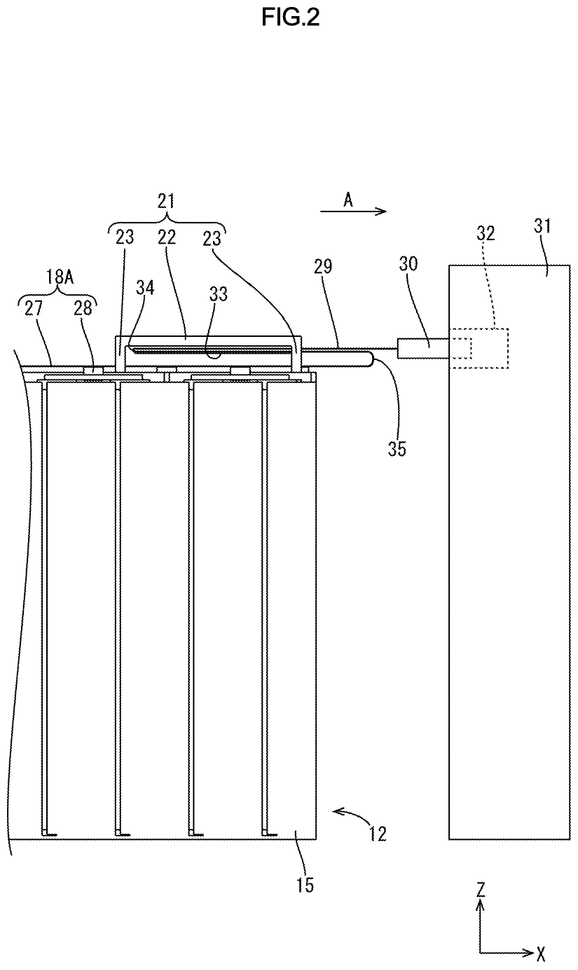

As illustrated in FIG. 2, the line-side connector 30 is fit in a device-side connector 32 included in a control unit 31 to be electrically connected to the control unit 31. The control unit 31 receives signals related to the condition of the power storage elements 11 through the flat line 18 and monitors the condition of each power storage element 11 based on the signals and controls charging and discharging of the power storage module 10.

As illustrated in FIG. 6, a bending restricting plate 33 is disposed on an upper surface of the extra section 29. The bending restricting plate 33 extends from a left side position from a right end of the extra section 29 to a substantially middle position with respect to the left-right direction. The bending restricting plate 33 is fixed to the flat line 18 with a known method such as bonding or heat melt welding.

The bending restricting plate 33 has a rectangular shape seen from the above. The bending restricting plate 33 has a width dimension in the front-rear direction that is same as or slightly smaller than the width dimension of the flat line 18 in the front-rear direction. The bending restricting plate 33 is fixed to the flat line 18 while being disposed on the flat line 18. According to such a configuration, the flat line 18 is less likely to be bent in an area where the bending restricting plate 33 is fixed. The bending restricting plate 33 is made of appropriate material such as a synthetic resin plate or a metal plate. For example, polyester such as polyethylene terephthalate and polybutylene terephthalate, polyamide such as nylon 6 and nylon 6, 6, and epoxy resin containing glass fiber may be used as appropriate.

The extra section 29 includes a first bending portion 34 and a second bending portion 35. The first bending portion 34 is closer to the device-side connector 32 with respect to the bending restricting plate 33 and the second bending portion 35 is closer to the power storage element group 12 with respect to the bending restricting plate 33. The extra section 29 is arranged below the top plate portion 22 of the holding member 21 while being bent at the first bending portion 34 and the second bending portion 35.

The extra section 29 of the flat line 18 is bent at the first bending portion 34 at an acute angle seen from a side. In other words, the extra section 29 of the flat line 18 is folded at the first bending portion 34.

On the other hand, the extra section 29 of the flat line 18 is bent at the second bending portion 35 in a curved shape seen from a side. In other words, the second bending portion 35 has a curved surface.

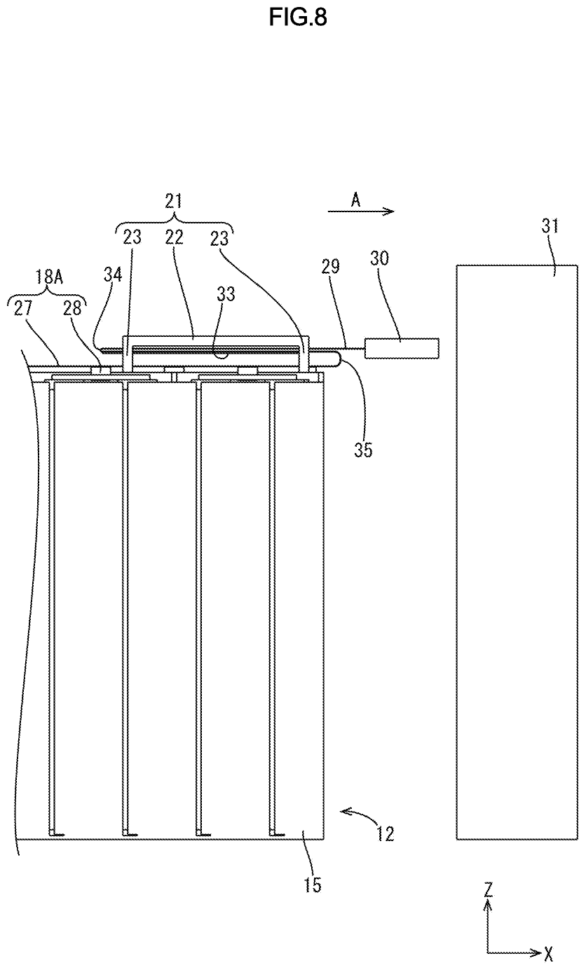

As illustrated in FIG. 8, since the flat line 18 is moved in a direction of the arrow A to be closer to the control unit 31 at the first bending portion 34, the portion of the extra section 29 of the flat line 18 between the second bending portion 35 and the line-side connector 30 becomes closer to the control unit 31. Accordingly, the line-side connector 30 can be connected to the device-side connector 32 of the control unit 31.

### One Example of Producing Process

Next, one example of a process of producing the power storage module 10 according to the present embodiment will be described. The process of producing the power storage module 10 is not limited to the one described below.

The line-side connector 30 is connected to the end of the flat line 18. The extended sections 28 of the flat line 18 are connected to the bus bars 25 and the edge-side bus bars 26, respectively, with soldering, for example. The bending restricting plate 33 is fixed to a predefined position of the flat line 18.

The power storage elements 11 are arranged in the respective arrangement sections 16 of the separator 15, respectively. The flat lines 18 are disposed on the respective disposing sections 19 of the separator 15 such that the electrode terminals 14 of the power storage elements 11 overlap the bus bars 25 and the edge-side bus bars 26, respectively. For example, the electrode terminals 14 are connected to the bus bars 25 and the electrode terminals 14 are connected to the edge-side bus bars 26, respectively, with laser welding.

The flat line 18 is gently bent at a portion that is on a right side of the bending restricting plate 33 to form the second bending portion 35. The flat line 18 is bent at a predefined portion at an acute angle to form the first bending portion 34.

The holding member 21 is attached to the separator 15 from an upper side of the flat line 18 that is bent at the first bending portion 34 and the second bending portion 35. Accordingly, the flat line 18 is retained below a base portion of the holding member 21 while being bent at the first bending portion and the second bending portion 35.

The power storage module 10 and the control unit are fixed to predetermined portions in a vehicle. The line-side connector 30 is moved closer to the control unit 31 such that the flat line 18 is entirely moved to a left side (in a direction illustrated by the arrow A) at the first bending portion 34. Thus, the line-side connector 30 is fitted to the device-side connector 32 of the control unit 31.

### Operations and Advantageous Effects of the Present Embodiment

Next, operations and advantageous effects of the present embodiment will be described. The wiring module 13 according to the present embodiment includes the flat line 18 that is a flexible printed circuit board or a flexible flat cable and the line-side connector 30 that is connected to an end portion of the flat line 18. The flat line 18 is mounted on the power storage element group 12 including the power storage elements 11. The line-side connector 30 is to be fitted to the device-side connector 32 included in the control unit 31 of the power storage element group 12. The flat line 18 includes the extra section 29 that extends from the power storage element group 12 and the bending restricting plate 33 is disposed on a portion of the extra section 29.

According to the above configuration, the portion of the extra section 29 where the bending restricting plate 33 is disposed is less likely to be bent. This suppresses the extra section 29 from moving freely due to vibrations. Therefore, the extra section 29 is less likely to be deformed or come in contact with any obstacles. On the other hand, the portion of the extra section 29 where the bending restricting plate 33 is not disposed is allowed to move to follow the movement of the line-side connector 30.

Furthermore, in the present embodiment, the extra section 29 includes the first bending portion 34 that is closer to the device-side connector 32 with respect to the bending restricting plate 33 and the second bending portion 35 that is closer to the power storage element group 12 with respect to the bending restricting plate 33. At least one of the first bending portion 34 and the second bending portion 35 has a curved surface.

According to the above configuration, even if the positions of the power storage element group 12 and the device-side connector 32 do not correspond to each other, one of the first bending portion 34 and the second bending portion 35 having a curved surface is deformed and warped to absorb such a position displacement.

According to the present embodiment, the extra section 29 is folded at the first bending portion 34 and has a curved surface at the second bending portion 35.

According to the above configuration, it is clear that the portion extending from the first bending portion 34 to the device-side connector 32 corresponds to a stroke length necessary for the fitting to the device-side connector 32. This improves operation efficiency for fitting the line-side connector 30 to the device-side connector 32.

According to the present embodiment, the flat line 18 includes the extended sections 28 extending outwardly from the side edge. The bus bar 25 is connected to at least one of the electrode terminals 14 included in the power storage elements 11.

According to the above configuration, the extended section 28 of the flat line 18 is connected to the bus bar 25 that is connected to the electrode terminal 14 of the power storage element 11. Therefore, compared to the configuration including multiple lines for detecting voltages of the power storage elements 11, the space can be saved.

### Other Embodiments

The technology disclosed herein is not limited to the embodiment described above and illustrated in the drawings. For example, the following embodiments will be included in the technical scope of the technology.

(1) In the above embodiment, the wiring module 13 includes the holding member 21 that holds the extra section 29. However, the present technology is not limited to this configuration and the holding member 21 may not be included.

(2) In the above embodiment, the disposing section 19 is integrally included in the separator 15. However, the present technology is not limited to this configuration. The disposing section 19 included as a component separately from the separator 15 may be mounted on the separator 15.

(3) In the above embodiment, the flexible printed circuit board is used as the flat line 18. However, the present technology is not limited to this configuration and the flexible flat cable may be used as the flat line 18.

(4) Only one flat line 18 or three or more flat lines 18 may be included.

(5) In the present embodiment, the extra section is bent at the first bending portion 34 at an acute angle and gently bent at the second bending portion 35. However, the present technology is not limited to this configuration. The extra section may be gently bent at the first bending portion and bent at the second bending portion 35 at an acute angle. The extra section may be bent at an acute angle at the first bending portion 34 and the second bending portion 35 or may be bent gently at the first bending portion 34 and the second bending portion 35.

### EXPLANATION OF SYMBOLS

11: power storage element

12: power storage element group

13: wiring module

14: electrode terminal

18: flat line

25: bus bar

26: edge-side bus bar

28: extended section

29: extra section

30: line-side connector

31: control unit

32: device-side connector

33: bending restricting plate

34: first bending portion

35: second bending portion

1. A wiring module comprising:
a flat line that is mounted on a power storage element group including power storage elements and is one of a flexible printed circuit board and a flexible flat cable; and
a line-side connector that is connected to an end portion of the flat line and to be fitted to a device-side connector included in a control unit of the power storage element group, wherein
the flat line includes an extra section extending from the power storage element group and a bending restricting plate is disposed on a portion of the extra section.

2. The wiring module according to claim 1, wherein
the extra section includes a first bending portion and a second bending portion, the first bending portion is closer to the device-side connector with respect to the bending restricting plate and the second bending portion is closer to the power storage element group with respect to the bending restricting plate, and
at least one of the first bending portion and the second bending portion has a curved surface.

3. The wiring module according to claim 2, wherein the extra section is folded at the first bending portion and has a curved surface at the second bending portion.

4. The wiring module according to claim 1, wherein
the flat line includes an extended section that extends outwardly from a side edge thereof,
the extended section is connected to a bus bar at an end thereof, and
the bus bar is connected to at least one of electrode terminals included in the power storage elements.
